(19) United States
(12) Patent Application Publication
(10) Pub. No.: US 2024/0184855 A1
(43) Pub. Date: Jun. 6, 2024

(54) TRAINING OF PREDICTION NETWORK FOR AUTOMATIC CORRELATION OF INFORMATION

(71) Applicant: Salesforce, Inc., San Francisco, CA (US)

(72) Inventors: Nachiketa Mishra, San Francisco, CA (US); Ziwei CHEN, Sodermanland County (SE)

(73) Assignee: Salesforce, Inc., San Francisco, CA (US)

(21) Appl. No.: 18/060,874

(22) Filed: Dec. 1, 2022

(51) Int. Cl. G06F 18/22; G06N 3/08

(52) U.S. Cl. CPC G06F 18/22; G06N 3/08

(57) ABSTRACT

In some embodiments, a method receives machine generated input and user generated input for training a model of a prediction network. A link between a type of machine generated input and a type of user generated input. A first score that represents a correlation between the type of machine generated input and the type of user generated input is generated. The method analyzes the machine generated input and the user generated input using the model of the prediction network to correlate the machine generated input and the user generated input to a category. A second score associated with a confidence that the machine generated input or the user generated input belongs to the category is output. The method adjusts a parameter of the prediction network based on the first score and the second score.

### FIELD OF TECHNOLOGY

This patent document relates generally to neural networks and more specifically to correlation of information using the neural networks.

### BACKGROUND

Systems may be used to alert teams when there is a problem with an application. The system may automatically generate error reports that may surface errors during the execution of the application, which may affect the application's resiliency and in turn affect the trust of users of the application. Issue tickets may also be generated that include details related to any problems experienced by users of the application. It is useful to correlate the error reports with the issue tickets, such as it may be useful to determine which error reports may be causing the issue tickets, and the error reports can be used to troubleshoot the application. However, there may be many error reports that are generated by the system. Conventionally, the error reports and issue tickets may have to be correlated manually. When there are a lot of repeating and similar error reports, a large number of manual hours may be required to perform the correlation.

### BRIEF DESCRIPTION OF THE DRAWINGS

The included drawings are for illustrative purposes and serve only to provide examples of possible structures and operations for the disclosed inventive systems, apparatus, methods and computer program products for automatic correlation of information. These drawings in no way limit any changes in form and detail that may be made by one skilled in the art without departing from the spirit and scope of the disclosed implementations.

FIG. 1 depicts a simplified system for correlating error reports and issue tickets according to some embodiments.

FIG. 2 depicts an example of error reports and issue tickets according to some embodiments.

FIG. 3 depicts a simplified flowchart of a method for a training model for a prediction network according to some embodiments.

FIG. 4 depicts an example of training system according to some embodiments.

FIG. 5 depicts an example of a prediction network according to some embodiments.

FIG. 6 depicts simplified flow chart of a method for performing error processing according to some embodiments.

FIG. 7 depicts a simplified flow chart for processing the output of the prediction network according to some embodiments.

FIG. 8 depicts a more detailed example of resolution system according to some embodiments.

FIG. 9 shows a block diagram of an example of an environment that includes an on-demand database service configured in accordance with some implementations.

FIG. 10A shows a system diagram of an example of architectural components of an on-demand database service environment, configured in accordance with some implementations.

FIG. 10B shows a system diagram further illustrating an example of architectural components of an on-demand database service environment, in accordance with some implementations.

FIG. 11 illustrates one example of a computing device.

### DETAILED DESCRIPTION

A system may correlate machine generated information, such as error reports, and user generated information, such as issue tickets. Error reports may be automatically generated by a computing platform and may contain machine generated information that is based on an issue associated with the execution of an application. The computing platform may generate an error report that includes technical information and it is primarily used by software engineers to troubleshoot an issue with the application. For example, an error report may include a stack trace of the execution of software code of the application. In some examples, the fields in the error report may be automatically generated by a platform and include technical traces of the execution of the software code that is running for the application across multiple components of a computing platform.

An issue ticket may be generated by a user and include details on a problem experienced by the user of the application. For example, issue tickets may be generated by support personnel and include details based on the issue experienced by users of the application. The issue ticket may include text that describes the problem. Conventionally, the correlation of error reports and issue tickets was a manual process that may be performed by a user with technical expertise in the technical domain and knowledge of the internal technologies of the application. This used very valuable time. Also, error reports or issue tickets may be repeated multiple times, which required the users to spend extra time to perform the correlation repeatedly. The present system may automatically correlate error reports and issue tickets.

In some examples, a user of Company X may be using an application and an error occurs. In response, the computing platform may generate an error report. Also, the same user or another user may generate an issue ticket that describes the problem encountered. The above may happen multiple times for the same user or different users. Conventionally, a technical person such as a software engineer, who has domain expertise and knowledge of the application, may correlate the issue tickets and the error reports manually. However, in some embodiments, the system may automatically correlate error reports and issue tickets. For example, the system may correlate an error report with a category, which may be associated with a previously submitted issue ticket. Then, a resolution associated with the category, such as one that was used to resolve the previously submitted issue ticket, may be associated with the error report. That resolution may then be used to troubleshoot the application faster than if manual correlation was performed, which may fix the problem such that the users may not experience the problem anymore. As will be described in more detail below, a prediction network may be trained to perform the correlation and then used to correlate error reports and issue tickets.

### System

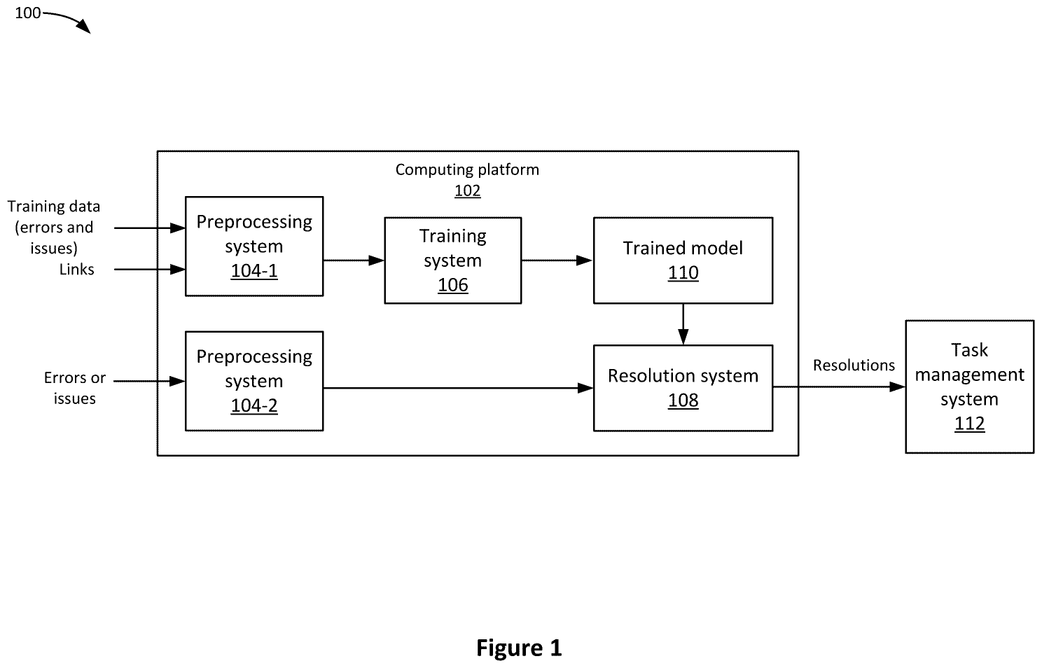

FIG. 1 depicts a simplified system 100 for correlating error reports and issue tickets according to some embodiments. System 100 includes a computing platform 102 that performs the correlation between error reports and issue tickets. Computing platform 102 may be implemented using one or more computing devices that can perform functions as described, such as in a distributed manner in a cloud environment. However, other types of platforms may be used. Computing platform 102 includes a pre-processing system 104, a training system 106, a resolution system 108, trained model 110, and task management system 112. An application may also be executed, such as by computing platform 102 or another computing system. The application may be used in a multi-tenant environment and be accessed by users. However, other environments may be appreciated. Although an application is described, the use of the term application may also include a system that is executing the application. That is, error reports and issue tickets may be generated for a system, a platform, or other computing device that is running one or more applications.

Error reports may include information that is generated automatically from the execution of an application, such as by the application itself or computing platform 102. Issue tickets may be information that may be generated manually by a user based on the use of the application by users. In some embodiments, the information in error reports is machine generated and the information in issue tickets is user generated. In some examples, a user may be using an application to perform a task and as the application is executed, a problem may be detected. The application automatically generates an error report that includes technical information, such as a stack trace of software code that is executed across components of application. A stack trace may be a report of the active stack frames at a certain point in time during the execution of the application when the error occurred. The error reports may include multiple fields that may include information that may be technical and hard to understand by a human reader. Also, the user that was using the application may get an error. This may cause the user or another user to submit an issue ticket. For example, the user may call customer service, and support personal may submit an issue ticket that describes the problem being experienced by the user. In contrast to the error report, the issue ticket may be written by a human user in natural language and may be more easily understood by a human reader. The correlation between the error reports and the issue tickets may be difficult due to the differences in the information included in each, and the different methods of how the error reports and issue tickets are generated.

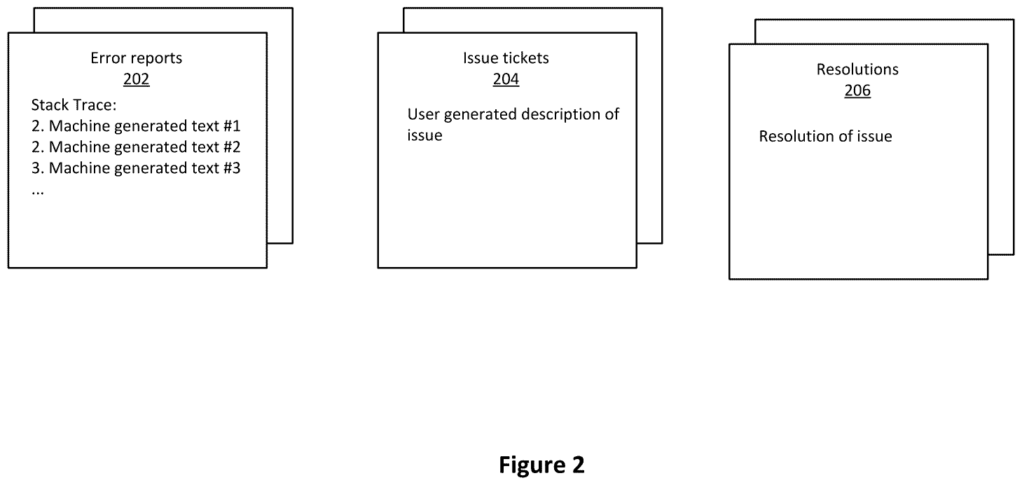

FIG. 2 depicts an example of error reports and issue tickets according to some embodiments. Error reports 202 include machine generated information, which is shown as a stack trace. The stack trace may include the calls of functions of the application and where an error occurs in the application. Issue tickets 204 include a user generated description of an issue. The text of error reports 202 and issue tickets 204 may be different, but may be correlated in that an error report 202 may be associated with an error that caused the issue ticket 204 to be created. Once an issue ticket 204 is created, a user may attempt to resolve the issue, such as by reviewing error reports 202. A resolution 206 to issue ticket 204 may then be stored and associated with the issue ticket 204. Resolution 206 may indicate information on how to resolve the issue. There may be multiple error reports 202, issue tickets 204, and resolutions 206. In some cases, multiple error reports are generated for the same issue, such as multiple users may be using the application and trigger the same error. Each error report 202 may be similar, but may include slightly different information in the stack trace. Also, multiple issue tickets 204 may be issued for an error. The following will describe an improved process for correlating error reports 202 and issue tickets 204, and then using the correlation to provide resolutions 206 for error reports 202 or issue tickets 204.

Referring back to FIG. 1, a prediction network, such as a neural network, may be used to perform the correlation between error reports and issue tickets. First, a model 110 for the prediction network may be trained. Then, an error report may be correlated with a category associated with an issue ticket using trained model 110. Upon being correlated to a category, an associated resolution may be determined.

In the training process, computing platform 102 receives training data as input to perform the training of a model 110. For example, the input may include error reports, issue tickets, and metadata for links. The links may include associations between the error reports and issue tickets that are used to guide the training of model 110. For example, domain knowledge may be leveraged to determine that a type of error report should be associated with a type of issue ticket. In some examples, there may be an error report that is associated with a pre-existing feature and an issue ticket that is associated with a new feature. The metadata may indicate that these types are not related and can be used to train the prediction network to predict the error report and issue ticket are not related.

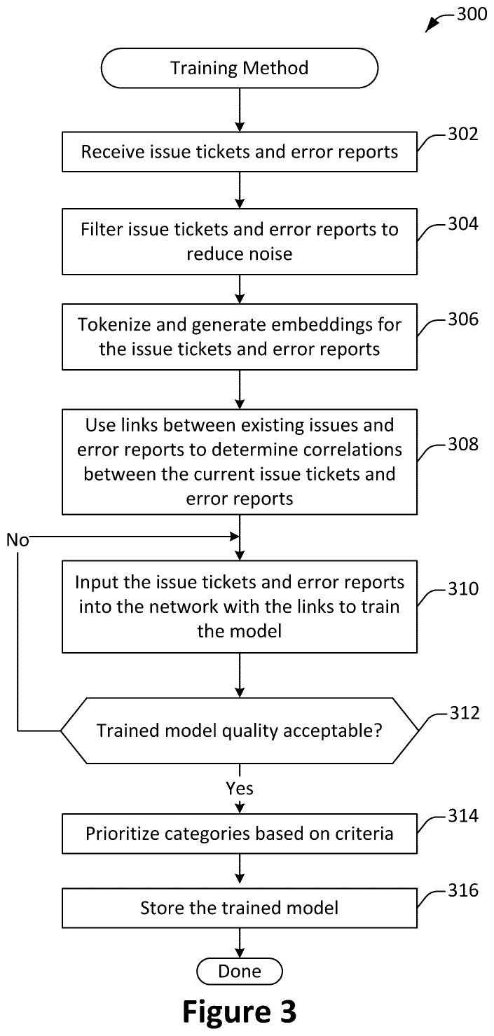

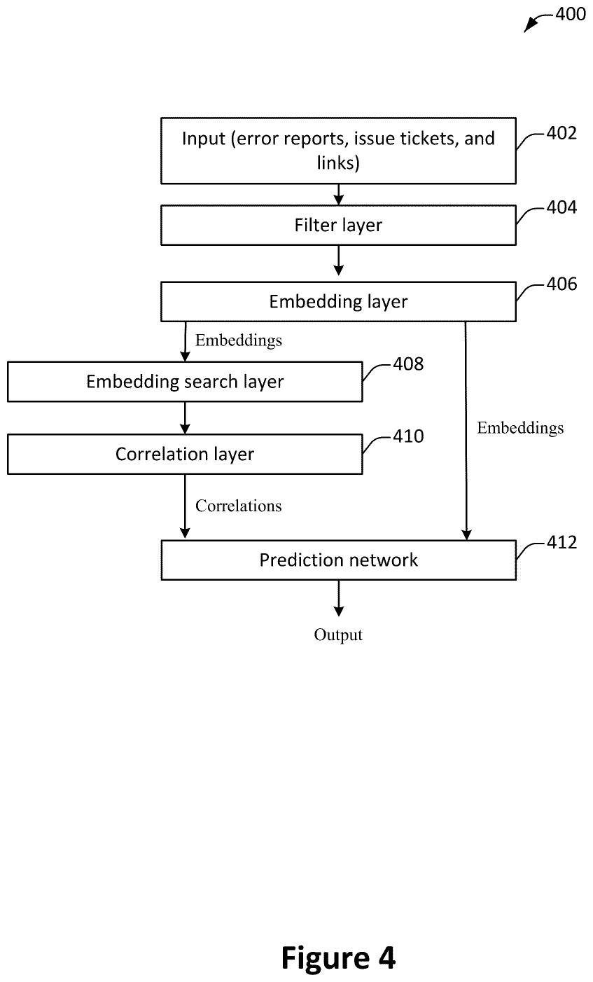

The input may be pre-processed for the training system 106. For example, pre-processing system 104-1 receives the training data and the links. Then, pre-processing system 104-1 may generate representations for the error reports and issue tickets. The representations may be a representation of the error report or issue ticket in a space, such as an embedding that may represent the information of the error ticket or issue ticket in an embedding space. In some embodiments, the embedding may be a multi-dimensional embedding. For example, a term may have meaning in multiple dimensions, such as a term princess may be related to a term woman, or a term prince in different ways. Pre-processing system 104-1 may also remove duplicate error reports or issue tickets to reduce the amount of information that is used for training. The pre-processing will be described in more detail below with respect to FIGS. 3 and 4.

Training system 106 receives the pre-processed information and can train model 110 using the information. In some embodiments, the training is unsupervised, which means that the information is not labeled with a known result that can be used to measure the performance of the prediction network. For example, the correlation between an error report and an issue ticket is not labeled by a user. With the amount of error reports and issue tickets that need to be used to train model 110, the manual labeling may not be feasible. Thus, training system 106 trains model 110 to perform the correlation using the input information without the labels. The training may determine categories in which error reports or issue tickets may be categorized. For example, category #1, category #2, etc. may be determined. Issue tickets and error reports may be categorized in the same category #1. To improve the training, the links may be used by training system 106 to learn the similarities between the error reports and issue tickets. For example, the links may indicate that a type of issue ticket and a type error report are not related. A type of error report may be a specific error report that was received or information from an error report. Also, a type of issue ticket may be a specific issue ticket or information from an issue ticket. When a link indicates the type of error report and issue ticket are not related, this may mean that training system 106 should not categorize them in category #1. Then, training system 106 may use the links to adjust parameters of model 110 in the training. In the above example, if the links indicate the error report and the issue ticket are not related, parameters of the prediction network may be adjusted to recognize they should not be classified in the same category. On the other hand, if the link had indicated that the error report and the issue ticket are related, parameters of the prediction network may be adjusted to recognize they should be classified in the category with a higher confidence. The training will be described in more detail below in FIGS. 3 and 4.

Once the model 110 is trained, training system 106 may store model 110 in storage. Although only one model 110 is discussed, multiple models 110 may be trained and used in by the prediction network.

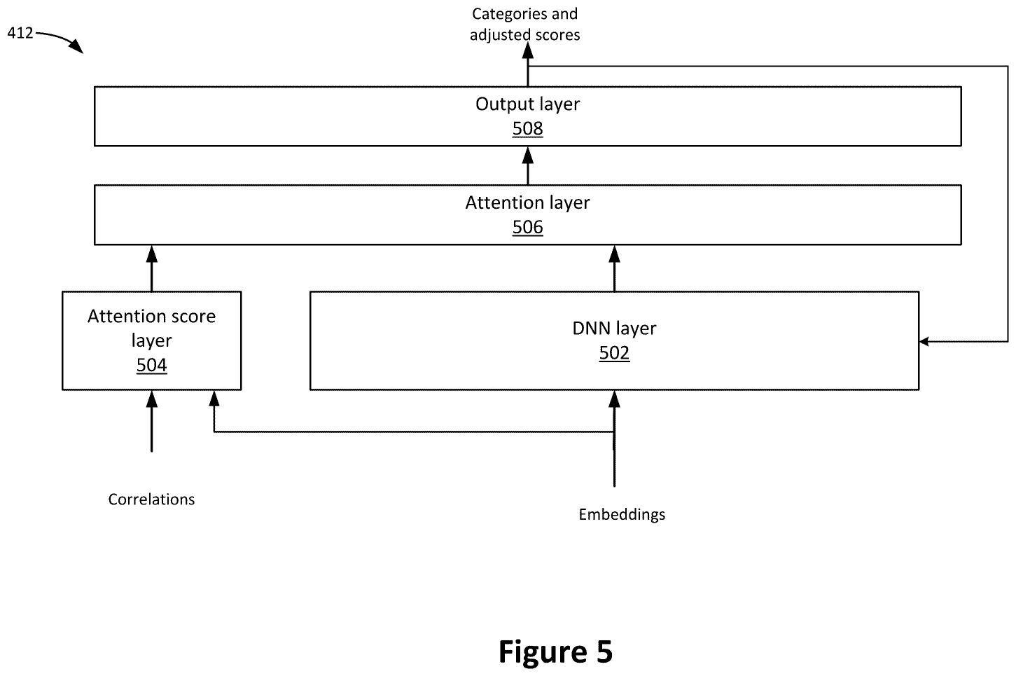

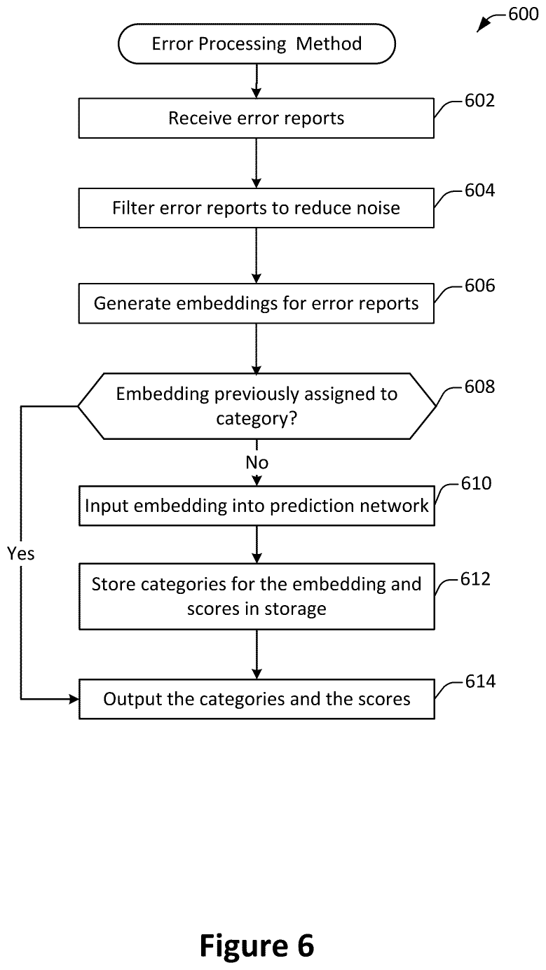

After training model 110, resolution system 108 may process error reports or issue tickets. In the process, pre-processing system 104-2 may receive error reports or issue tickets. Pre-processing system 104-2 may then pre-process the error reports or issue tickets by generating an embedding. Further, pre-processing system 102-2 may remove any duplicate error reports or issue tickets to reduce the amount of processing that is to be performed at resolution system 108. The pre-processing may be described in more detail in FIGS. 5 and 6.

Resolution system 108 receives the input and then can generate an output that is used to determine a resolution as output. In some embodiments, resolution system 108 may analyze an error report and determine one or more categories for the error report. Additionally, resolution system 108 may output a confidence score for each category. For example, an error report may be categorized in a category #1 with a confidence of 80%, a category #2 with 10% confidence and a category #3 with confidence of 3%. Each category may be associated with an issue report and/or a resolution. For example, each category is associated with a previously submitted issue ticket (or group of issue tickets) and a resolution that has been previously determined for the issue ticket. If resolution system 108 determines a category that has a confidence score that meets a threshold (e.g., a confidence score above 80%), then resolution system 108 may categorize the error report in that category and create an issue ticket for the error report that includes the determined resolution for the category. However, if all confidence scores for the categories do not meet the threshold (e.g., are less than 80%), resolution system 108 may alert a user to process the error report, such as to generate an issue ticket for the error report.

Task management system 112 may use the output of resolution system 108. Task management system 112 may manage issue tickets and resolutions. For example, issue tickets are opened in task management system 112 and when resolutions are determined, issue tickets may be closed. Resolution system 108 may open an issue ticket for an error report with information from the prediction network. As discussed above, the issue ticket may be associated with the category and include information for a possible resolution. This improves the processing of error tickets because an issue ticket does not have to be manually created, an error report does not have to be manually correlated to issue reports, and a resolution does not have to be manually determined. Also, task management system 112 may more efficiently manage issue tickets because the issue tickets may be more efficiently processed using the associated resolution.

### Training Process

FIG. 3 depicts a simplified flowchart 300 of a method for training a model 110 for a prediction network according to some embodiments. At 302, pre-processing system 104-1 receives issue tickets, error reports, and links between error reports and issue tickets. At 304, pre-processing system 104-1 filters issue tickets and error reports to reduce noise. For example, deduplication filters may be used to determine issue tickets or error reports that are similar in the input data. In some examples, multiple error reports may be generated for the same error, such as when multiple users are using the application. The error reports may be similar, but may not be exact. For example, the stack trace may include similar function calls, but the information included in the stack trace may differ slightly. Pre-processing system 104-1 may detect error reports that may be from the same error by detecting duplicate text, and filter out duplicate error reports. For example, a threshold may be used to determine an amount of duplicate text that may indicate error reports are from the same error.

At 304, pre-processing system 104-1 may tokenize the issue tickets and error reports, and generate embeddings for the issue tickets and the error reports. Tokenization may cut the input data into meaningful parts that can be embedded into an embedding space. For example, pre-processing system 104-1 may tokenize information from the stack traces of the error reports or entries from the issue tickets. In some examples, a natural language tokenizer or universal sentence tokenizer may tokenize the issue ticket details. For example, the token of the text “This is an error” of an error report or issue ticket may be tokenized into numbers such as “101”, “1037”, “1012”, “340”.

Training system 106 may generate embeddings from the tokens. In some examples, training system 106 may be trained on aggregated global word-word co-occurrence statistics from the token corpus to generate embeddings in the embedding space. Training system 106 may take the tokens and generate embeddings from the tokens. For example, from the above token values, embeddings for the tokens may be generated in multiple dimensions. That is, the embedding for one token “101” may be 0.0390, −0.0321, 0.0218, etc., the embedding for another token “1037” may be −0.0455, 0.1510, 0.4456, etc. The embedding represents the text of the error report or issue ticket in the embedding space.

At 308, training system 106 uses links between previous issue tickets and error reports to determine correlations between the issue tickets and error reports in the current input. The correlations that are determined between current issue tickets and error reports may indicate that a type of error report is linked to a type of issue ticket in the input. For example, the links are used for correlating the embeddings of error reports and the issue tickets that are input with the categories that are extracted from the issue tickets. For instance, a link may be between an error report with the metadata of {Error Code:NoAccess, ProductTag:ProductA, occurrences:5000} and an issue ticket with the metadata of {Issue Description:Customer cannot login to the website of ProductA, impacted user: 5000, severity 1}. The dimensions in the embeddings are {ErrorType:Access, Product:A, Frequency:Often}. The category may be extracted as {severity:1, topic:LoginIn}. The correlations may be used to train model 110

At 310, the issue tickets, error reports, and correlations are input into a prediction network to train model 110. The training of model 110 derives semantics similarity across the embedding space by recognizing linear substructures of the embeddings within the embedding space. The linear substructures determine more intricate relationships than can be captured by a similarity metric, which may be a single number. For example, the linear substructure may determine deeper relationships between a man and woman, which may be similar in that they are human beings, but may also be opposite. The training may train model 110 to extract categories from the error reports and issue tickets. For example, topic modeling may extract topics from the error reports and issue tickets that may be used as categories. Categories can be different information, such as a field from the error report or issue ticket, the severity level, a text description, topics extracted from the error or issue description, etc. The output of model 110 may be one or more categories that is extracted for an input, and associated confidence scores for the respective category. For example, the output for an issue ticket may category #1 with 80% confidence, category #2 with 20% confidence, and category #3 with 10% confidence. The output for an error report may category #1 with 90% confidence, category #2 with 70% confidence, and category #4 with 10% confidence.

At 312, training system 106 determines if the quality of trained model 110 is acceptable. For example, training system 106 may determine whether or not the categories in which error reports or issue tickets are classified is acceptable. For example, an error report is categorized in a category #1 with a confidence score of 90% and an issue report is categorized in the same category #1 with a confidence of 80%. If a link indicates that the error report and the issue report are correlated, then the quality of the model may be considered high because the model classified both with a high confidence. However, if the link indicates that the error report and the issue report are not correlated, then the quality of the model may be considered low because the model classified both in the same category with a high confidence.

When the model is trained acceptably, at 314, training system 106 prioritizes categories based on criteria. For example, if a category #1 includes 1000 error reports and issue tickets with a confidence above 80% and a category #2 includes 10 error reports and issue tickets with a confidence above 80%, the category with 1000 error reports may be prioritized as being an important category because there may be a large number of errors or issues occurring in this category. In some examples, the higher priority categories may be used, but lower priority categories may be removed from being classified by model 110. As model 110 is retrained, focusing on the higher priority categories may adjust the parameters of model 110 to classify issue tickets or error reports more accurately. For each category, training system 106 may associate a resolution. For example, the category may be associated with an issue report and the resolution for that issue report is associated with the category.

At 316, training system 106 stores the trained model 110. Although a single model has been discussed, training system 106 may train multiple models 110.

FIG. 4 depicts an example of training system 106 according to some embodiments. at 402, input is received which may include error reports, issue tickets, and links between error reports and issue tickets.

A filter layer 404 may detect duplicate error reports and/or issue tickets and remove the duplication of the error reports or issue tickets. Filter layer may use deduplication logic to detect duplicate error reports or issue tickets.

An embedding layer 406 may generate embeddings from the input. The embeddings may be processed at an embedding search layer 408. Embedding search layer 408 may determine embeddings for error tickets and issue tickets that are similar, which may reduce the amount of embeddings that are analyzed. Also, a correlation layer 410 may determine correlations between the error reports and issue tickets. Correlation layer 410 may use the links that are received and also information from the embedding search to determine the correlations. For example, correlation layer 410 may determine that an embedding for an error report and an embedding for an issue ticket are similar. The correlations are input into a prediction network 412. Also, the embeddings for the error reports and issue tickets are input into prediction network 412. The training may extract categories as topics using statistical analysis of the error reports and issue tickets. For example, from the details in the error reports or issue tickets, topics may be generated as categories. The error reports and issue tickets are also categorized in the categories with associated confidence scores. The following will now describe the training in more detail.

FIG. 5 depicts an example of prediction network 412 according to some embodiments. The training system may apply attention to nodes or layers of the prediction network based on the correlations that are determined. The attention may characterize a similarity between embeddings based on the correlations. The following will describe an example of a prediction network, but other examples may be appreciated.

The embeddings may be input into a neural network layer, such as a deep neural network (DNN). The neural network may include multiple layers that analyze the similarity of embeddings to categories. For example, DNN layer 502 may output a set of categories for an embedding with a confidence score for the category. The category may be one of the categories that were determined during the training phase. Also, if a category cannot be determined, DNN layer 502 may output a category not found during the training phase, such as a new category or an unknown category with a confidence score.

The correlations from the links and embeddings may be input into an attention score layer 504. Attention score layer 504 may generate a representation for the correlations, such as a vector for each correlation. The vector may represent a correlation between an issue ticket and an error report. For example, attention score layer 504 computes attention scores based on similarity between error reports and issue tickets to a category. A higher attention score for a category for an error report and an issue ticket may give more weight to a result from DNN layer 502 that classifies the error report and the issue ticket in the category. A lower attention score for a category for an error report and an issue fee may give less weight to a result from DNN layer 502 that classifies the error report and the issue ticket in the category.

An attention layer 506 may apply the attention score to the output of DNN layer 502. For example, the confidence scores for a category may be adjusted by the attention scores. As mentioned above, a higher attention score for a category may result in adjusting a confidence score to be higher or a lower attention score for a category may result in adjusting a confidence score to be lower when the error report and the issue ticket is classified in that category. In some embodiments, the attention score for each category may be combined (e.g., multiplied) with the confidence score for the respective category.

An output layer 508 may generate categories and adjusted confidence scores from the output of attention layer 506. Output layer 508 may also determine whether parameters should be adjusted. For example, if the attention score indicates that an error report and issue ticket are similar, and the output indicates that the error report and issue ticket are not similar, then attention layer 408 may adjust parameters of DNN layer 502 such that the prediction network determines the error report and the issue ticket are similar. For example, a difference between the adjusted score and the confidence score output by DNN layer 502 may be compared and a difference is used to adjust the parameters of model 110. Also, attention may be applied at different points of DNN layer 502, such as after a layer in DNN layer 502 (a hidden layer), after the output of the last layer, etc. Once the training is performed, error reports and issue tickets may be processed using trained model 110.

### Error Processing Method.

FIG. 6 depicts simplified flow chart 600 of a method for performing error processing according to some embodiments. At 602, resolution system 108 receives error reports. At 604, resolution system 108 filters the error reports to reduce noise. At 606, resolution system 108 generates embeddings for the error reports.

At 608, resolution system 108 determines if an embedding has been previously assigned to a category. This could occur if multiple error reports are the same. [If the embedding has not been previously assigned to a category, at 610, resolution system 108 inputs the embedding into a prediction network that uses a trained model 110. The prediction network may then output categories for the embedding with respective scores for the categories. For example, the output may be a category #1 with a confidence score of 80%, a category #2 with a confidence score of 10%, a category #3 with a confidence score of 3%. In this example, the prediction network predicts the error report should be classified in category #1 with a high confidence, and categories #2 and #3 with a low confidence. At 612, resolution system 108 stores the categories for the embedding and the respective scores in storage. These categories and scores may be used to determine if an embedding has been previously assigned to a category as recited in 608 above.

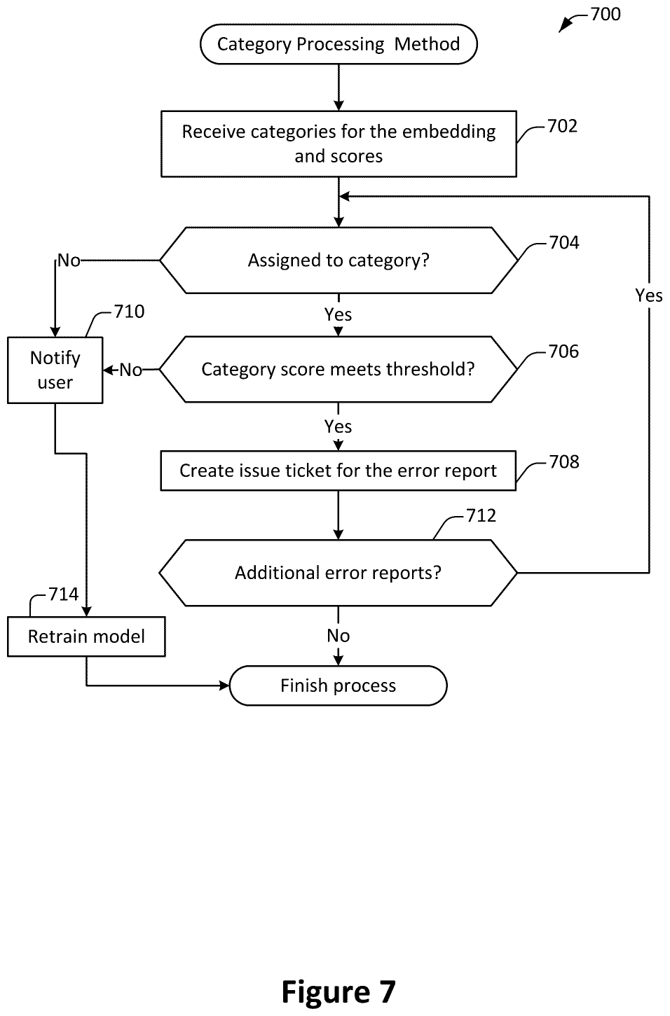

At 614, resolution system 108 outputs the categories and the scores. The outputted categories and scores may be processed in different ways. FIG. 7 depicts a simplified flow chart 700 for processing the output of the prediction network according to some embodiments. At 702, resolution system 108 receives the categories for the embedding and the respective scores. At 704, resolution system 108 determines if the embedding was assigned to a category. It may be possible that the error report is not assigned to any category or to a new or unknown category. In this case, at 710, resolution system 108 may generate an alert to notify a user. The user may then take an action to manually assign a category to the error report.

At 706, resolution system 108 determines if a category score meets a threshold. For example, resolution system 108 may determine if a category with the highest score meets a threshold. In some examples, resolution system 108 may require that a category score be greater than 80% confidence, but other values may be used.

If the category score does not meet a threshold, then at 710, resolution system 108 may generate an alert to notify a user. Once again, the user may manually categorize the error report or perform some other actions.

If the category score meets a threshold, at 708, resolution system 108 creates an issue ticket for the error report. The issue ticket that is created may be based on the category that is determined. For example, the category may be associated with an issue ticket and a possible resolution that was determined from a prior issue ticket. Then, with the issue ticket and previous resolution, a user can troubleshoot the problem using this information. This is much faster than having a user receive the error report, correlate the error report to an issue ticket, and then determine a resolution.

At 712, resolution system 108 determines if there are any additional error reports. If so, the process reiterates to 704 to process another error report. The process continues until there are no additional error reports to process.

There may be times when model 110 may need to be retrained. For example, if no categories are output for an error report, no categories meet a threshold, or a new category is output, training of model 110 may be reperformed, such as at 714. The retraining may be performed to recognize a new category if multiple error reports are being categorized in a new category or an unknown category. Also, the training may leverage new information from the user to retrain model 110 to better recognize the error report.

The above process was described as receiving error reports. However, issue reports may be processed also. For example, resolution system 108 may receive an issue report, and determine a category for the issue report. Then, a resolution for the category may be output for the issue report.

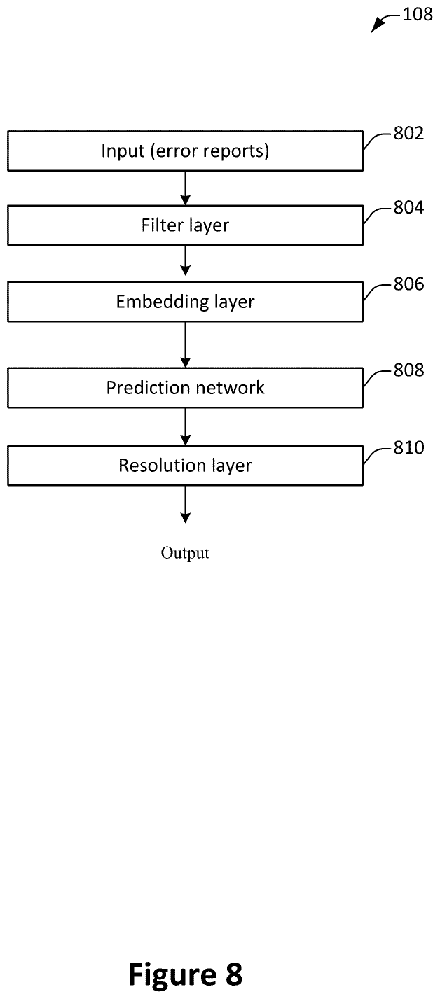

FIG. 8 depicts a more detailed example of resolution system 108 according to some embodiments. Resolution system 108 may not use the links and attention that were used in the training phase. The links are not used because the model has been trained to categorize error reports in categories. At 802, input is received, such as error reports. A filter layer 804 may detect duplicate error reports and remove the duplicate error reports. This may reduce the amount of processing that is needed to categorize the error reports. An embedding layer 806 may generate embeddings for the input. Then, a prediction network 808 may process the embeddings to categorize them with respective confidence scores. Prediction network 808 may use a trained model 110. Finally, a resolution layer 810 may perform processing of the categories to determine whether or not the error report is associated with an issue ticket for the category. Resolution layer 810 may automatically create issue tickets for the error report with a resolution that is associated with the category.

### CONCLUSION

In some examples, a large amount of error reports may be received, such as 30,000 error reports. To manually process this amount of error reports, an indeterminate number of manual resources may be used, which may not be possible. Accordingly, resolution system 108 may be used to automatically categorize error reports and create issue tickets with resolutions. This improves the error report processing system. The improvement in technology may be that unsupervised training of the prediction network is performed because the manual labeling of error reports may not be possible. The unsupervised training is performed using links between prior error reports and issue tickets that is enforced at various layers of the prediction network. For example, attention may be applied to layers based on the links to emphasize correlations between an error report and an issue ticket. The classification of error reports may also be improved. For example, the trained model may predict a category more accurately for an error report because the model was trained using the links. Also, the error ticket may be resolved faster by correlating the error ticket to a category that includes a resolution. This is an improvement over manually correlating error tickets.

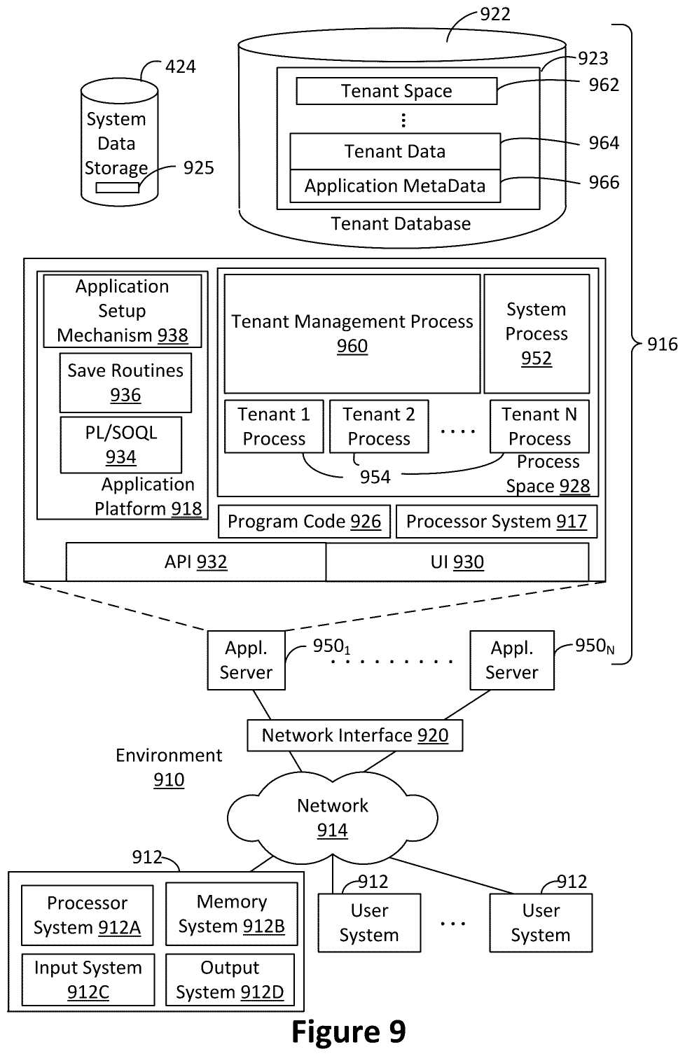

FIG. 9 shows a block diagram of an example of an environment 910 that includes an on-demand database service configured in accordance with some implementations. Environment 910 may include user systems 912, network 914, database system 916, processor system 917, application platform 918, network interface 920, tenant data storage 922, tenant data 923, system data storage 924, system data 925, program code 926, process space 928, User Interface (UI) 930, Application Program Interface (API) 932, PL/SOQL 934, save routines 936, application setup mechanism 938, application servers 950-1 through 950-N, system process space 952, tenant process spaces 954, tenant management process space 960, tenant storage space 962, user storage 964, and application metadata 966. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 916, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 918 may be a framework that allows the creation, management, and execution of applications in system 916. Such applications may be developed by the database service provider or by users or third-party application developers accessing the service. Application platform 918 includes an application setup mechanism 938 that supports application developers' creation and management of applications, which may be saved as metadata into tenant data storage 922 by save routines 936 for execution by subscribers as one or more tenant process spaces 954 managed by tenant management process 960 for example. Invocations to such applications may be coded using PL/SOQL 934 that provides a programming language style interface extension to API 932. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 966 for a subscriber making such an invocation. Such system processes may also manage execution of application metadata 966 as an application in a virtual machine.

In some implementations, each application server 950 may handle requests for any user associated with any organization. A load balancing function (e.g., an F5 Big-IP load balancer) may distribute requests to the application servers 950 based on an algorithm such as least-connections, round robin, observed response time, etc. Each application server 950 may be configured to communicate with tenant data storage 922 and the tenant data 923 therein, and system data storage 924 and the system data 925 therein to serve requests of user systems 912. The tenant data 923 may be divided into individual tenant storage spaces 962, which can be either a physical arrangement and/or a logical arrangement of data. Within each tenant storage space 962, user storage 964 and application metadata 966 may be similarly allocated for each user. For example, a copy of a user's most recently used (MRU) items might be stored to user storage 964. Similarly, a copy of MRU items for an entire tenant organization may be stored to tenant storage space 962. A UI 930 provides a user interface and an API 932 provides an application programming interface to system 916 resident processes to users and/or developers at user systems 912.

System 916 may implement a web-based system. For example, in some implementations, system 916 may include application servers configured to implement and execute software applications. The application servers may be configured to provide related data, code, forms, web pages and other information to and from user systems 912. Additionally, the application servers may be configured to store information to, and retrieve information from a database system. Such information may include related data, objects, and/or Webpage content. With a multi-tenant system, data for multiple tenants may be stored in the same physical database object in tenant data storage 922, however, tenant data may be arranged in the storage medium(s) of tenant data storage 922 so that data of one tenant is kept logically separate from that of other tenants. In such a scheme, one tenant may not access another tenant's data, unless such data is expressly shared.

Several elements in the system shown in FIG. 9 include conventional, well-known elements that are explained only briefly here. For example, user system 912 may include processor system 912A, memory system 912B, input system 912C, and output system 912D. A user system 912 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 912 to access, process and view information, pages and applications available from system 916 over network 914. Network 914 may be any network or combination of networks of devices that communicate with one another, such as any one or any combination of a LAN (local area network), WAN (wide area network), wireless network, or other appropriate configuration.

The users of user systems 912 may differ in their respective capacities, and the capacity of a particular user system 912 to access information may be determined at least in part by “permissions” of the particular user system 912. As discussed herein, permissions generally govern access to computing resources such as data objects, components, and other entities of a computing system, such as a prediction network system, a social networking system, and/or a CRM database system. “Permission sets” generally refer to groups of permissions that may be assigned to users of such a computing environment. For instance, the assignments of users and permission sets may be stored in one or more databases of System 916. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 916 may provide on-demand database service to user systems 912 using an MTS arrangement. By way of example, one tenant organization may be a company that employs a sales force where each salesperson uses system 916 to manage their sales process. Thus, a user in such an organization may maintain contact data, leads data, customer follow-up data, performance data, goals and progress data, etc., all applicable to that user's personal sales process (e.g., in tenant data storage 922). In this arrangement, a user may manage his or her sales efforts and cycles from a variety of devices, since relevant data and applications to interact with (e.g., access, view, modify, report, transmit, calculate, etc.) such data may be maintained and accessed by any user system 912 having network access.

When implemented in an MTS arrangement, system 916 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 916 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 916 may also maintain system-level data usable by multiple tenants or other data. Such system-level data may include industry reports, news, postings, and the like that are sharable between tenant organizations.

In some implementations, user systems 912 may be client systems communicating with application servers 950 to request and update system-level and tenant-level data from system 916. By way of example, user systems 912 may send one or more queries requesting data of a database maintained in tenant data storage 922 and/or system data storage 924. An application server 950 of system 916 may automatically generate one or more SQL statements (e.g., one or more SQL queries) that are designed to access the requested data. System data storage 924 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

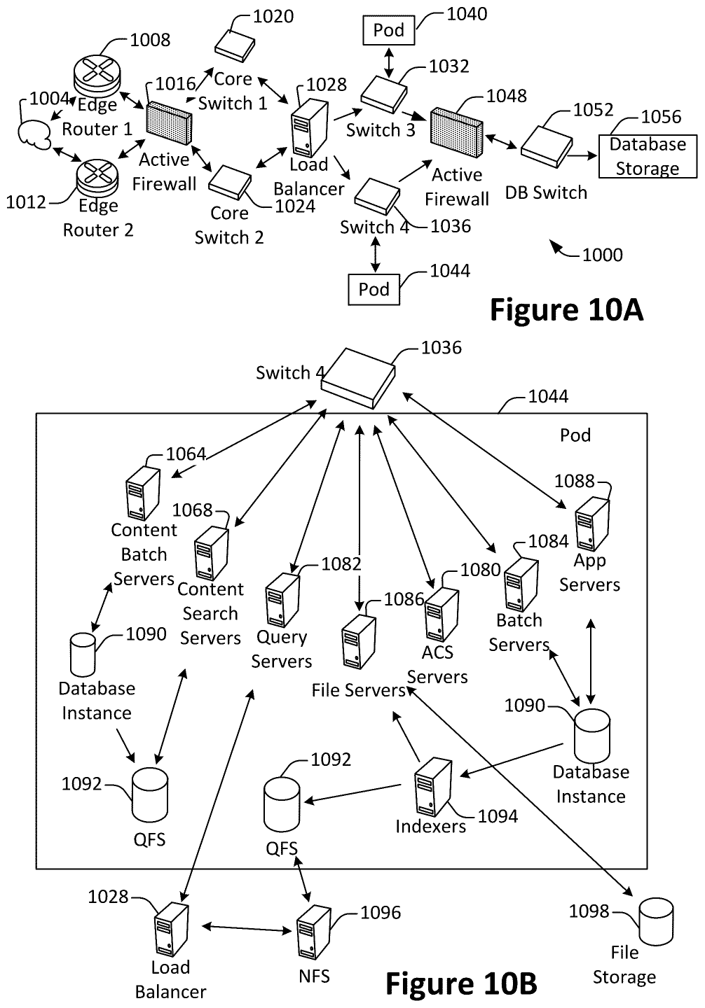

FIG. 10A shows a system diagram of an example of architectural components of an on-demand database service environment 1000, configured in accordance with some implementations. A client machine located in the cloud 1004 may communicate with the on-demand database service environment via one or more edge routers 1008 and 1012. A client machine may include any of the examples of user systems 912 described above. The edge routers 1008 and 1012 may communicate with one or more core switches 1020 and 1024 via firewall 1016. The core switches may communicate with a load balancer 1028, which may distribute server load over different pods, such as the pods 1040 and 1044 by communication via pod switches 1032 and 1036. The pods 1040 and 1044, which may each include one or more servers and/or other computing resources, may perform data processing and other operations used to provide on-demand services. Components of the environment may communicate with a database storage 1056 via a database firewall 1048 and a database switch 1052.

Accessing an on-demand database service environment may involve communications transmitted among a variety of different components. The environment 1000 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 10A and 10B.

The cloud 1004 refers to any suitable data network or combination of data networks, which may include the Internet. Client machines located in the cloud 1004 may communicate with the on-demand database service environment 1000 to access services provided by the on-demand database service environment 1000. By way of example, client machines may access the on-demand database service environment 1000 to retrieve, store, edit, and/or process error report or issue ticket information.

In some implementations, the edge routers 1008 and 1012 route packets between the cloud 1004 and other components of the on-demand database service environment 1000. The edge routers 1008 and 1012 may employ the Border Gateway Protocol (BGP). The edge routers 1008 and 1012 may maintain a table of IP networks or ‘prefixes’, which designate network reachability among autonomous systems on the internet.

In one or more implementations, the firewall 1016 may protect the inner components of the environment 1000 from internet traffic. The firewall 1016 may block, permit, or deny access to the inner components of the on-demand database service environment 1000 based upon a set of rules and/or other criteria. The firewall 1016 may act as one or more of a packet filter, an application gateway, a stateful filter, a proxy server, or any other type of firewall.

In some implementations, the core switches 1020 and 1024 may be high-capacity switches that transfer packets within the environment 1000. The core switches 1020 and 1024 may be configured as network bridges that quickly route data between different components within the on-demand database service environment. The use of two or more core switches 1020 and 1024 may provide redundancy and/or reduced latency.

In some implementations, communication between the pods 1040 and 1044 may be conducted via the pod switches 1032 and 1036. The pod switches 1032 and 1036 may facilitate communication between the pods 1040 and 1044 and client machines, for example via core switches 1020 and 1024. Also or alternatively, the pod switches 1032 and 1036 may facilitate communication between the pods 1040 and 1044 and the database storage 1056. The load balancer 1028 may distribute workload between the pods, which may assist in improving the use of resources, increasing throughput, reducing response times, and/or reducing overhead. The load balancer 1028 may include multilayer switches to analyze and forward traffic.

In some implementations, access to the database storage 1056 may be guarded by a database firewall 1048, which may act as a computer application firewall operating at the database application layer of a protocol stack. The database firewall 1048 may protect the database storage 1056 from application attacks such as structure query language (SQL) injection, database rootkits, and unauthorized information disclosure. The database firewall 1048 may include a host using one or more forms of reverse proxy services to proxy traffic before passing it to a gateway router and/or may inspect the contents of database traffic and block certain content or database requests. The database firewall 1048 may work on the SQL application level atop the TCP/IP stack, managing applications' connection to the database or SQL management interfaces as well as intercepting and enforcing packets traveling to or from a database network or application interface.

In some implementations, the database storage 1056 may be an on-demand database system shared by many different organizations. The on-demand database service may employ a single-tenant approach, a multi-tenant approach, a virtualized approach, or any other type of database approach. Communication with the database storage 1056 may be conducted via the database switch 1052. The database storage 1056 may include various software components for handling database queries. Accordingly, the database switch 1052 may direct database queries transmitted by other components of the environment (e.g., the pods 1040 and 1044) to the correct components within the database storage 1056.

FIG. 10B shows a system diagram further illustrating an example of architectural components of an on-demand database service environment, in accordance with some implementations. The pod 1044 may be used to render services to user(s) of the on-demand database service environment 1000. The pod 1044 may include one or more content batch servers 1064, content search servers 1068, query servers 1082, file servers 1086, access control system (ACS) servers 1080, batch servers 1084, and app servers 1088. Also, the pod 1044 may include database instances 1090, quick file systems (QFS) 1092, and indexers 1094. Some or all communication between the servers in the pod 1044 may be transmitted via the switch 1036.

In some implementations, the app servers 1088 may include a framework dedicated to the execution of procedures (e.g., programs, routines, scripts) for supporting the construction of applications provided by the on-demand database service environment 1000 via the pod 1044. One or more instances of the app server 1088 may be configured to execute all or a portion of the operations of the services described herein.

In some implementations, as discussed above, the pod 1044 may include one or more database instances 1090. A database instance 1090 may be configured as an MTS in which different organizations share access to the same database, using the techniques described above. Database information may be transmitted to the indexer 1094, which may provide an index of information available in the database 1090 to file servers 1086. The QFS 1092 or other suitable filesystem may serve as a rapid-access file system for storing and accessing information available within the pod 1044. The QFS 1092 may support volume management capabilities, allowing many disks to be grouped together into a file system. The QFS 1092 may communicate with the database instances 1090, content search servers 1068 and/or indexers 1094 to identify, retrieve, move, and/or update data stored in the network file systems (NFS) 1096 and/or other storage systems.

In some implementations, one or more query servers 1082 may communicate with the NFS 1096 to retrieve and/or update information stored outside of the pod 1044. The NFS 1096 may allow servers located in the pod 1044 to access information over a network in a manner similar to how local storage is accessed. Queries from the query servers 1022 may be transmitted to the NFS 1096 via the load balancer 1028, which may distribute resource requests over various resources available in the on-demand database service environment 1000. The NFS 1096 may also communicate with the QFS 1092 to update the information stored on the NFS 1096 and/or to provide information to the QFS 1092 for use by servers located within the pod 1044.

In some implementations, the content batch servers 1064 may handle requests internal to the pod 1044. These requests may be long-running and/or not tied to a particular customer, such as requests related to log mining, cleanup work, and maintenance tasks. The content search servers 1068 may provide query and indexer functions such as functions allowing users to search through content stored in the on-demand database service environment 1000. The file servers 1086 may manage requests for information stored in the file storage 1098, which may store information such as documents, images, basic large objects (BLOBs), etc. The query servers 1082 may be used to retrieve information from one or more file systems. For example, the query system 1082 may receive requests for information from the app servers 1088 and then transmit information queries to the NFS 1096 located outside the pod 1044. The ACS servers 1080 may control access to data, hardware resources, or software resources called upon to render services provided by the pod 1044. The batch servers 1084 may process batch jobs, which are used to run tasks at specified times. Thus, the batch servers 1084 may transmit instructions to other servers, such as the app servers 1088, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2º by IBM and the like without departing from the scope of present disclosure.

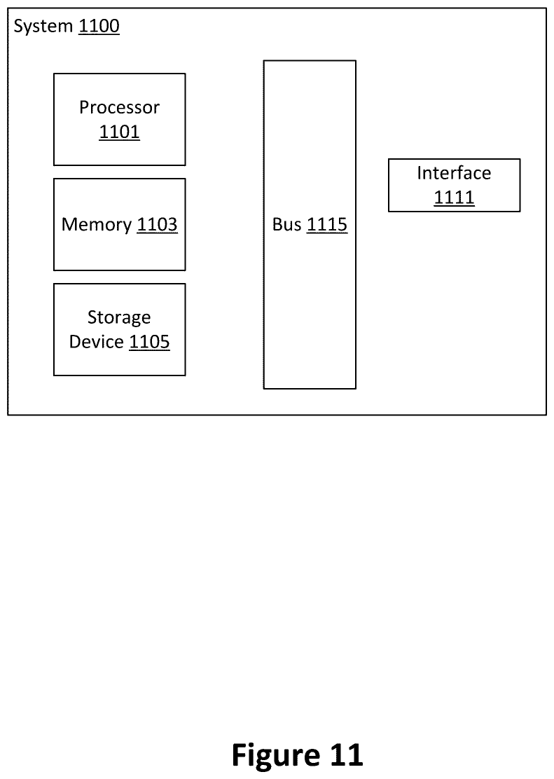

FIG. 11 illustrates one example of a computing device. According to various embodiments, a system 1100 suitable for implementing embodiments described herein includes a processor 1101, a memory module 1103, a storage device 1105, an interface 1111, and a bus 1115 (e.g., a PCI bus or other interconnection fabric.) System 1100 may operate as variety of devices such as an application server, a database server, or any other device or service described herein. Although a particular configuration is described, a variety of alternative configurations are possible. The processor 1101 may perform operations such as those described herein. Instructions for performing such operations may be embodied in the memory 1103, on one or more non-transitory computer readable media, or on some other storage device. Various specially configured devices can also be used in place of or in addition to the processor 1101. The interface 1111 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
receiving, by a computing device, machine generated input and user generated input for training a model of a prediction network;
receiving, by the computing device, a link between a type of machine generated input and a type of user generated input;
generating, by the computing device, a first score that represents a correlation between the type of machine generated input and the type of user generated input;
analyzing, by the computing device, the machine generated input and the user generated input using the model of the prediction network to correlate the machine generated input and the user generated input to a category, wherein a second score associated with a confidence that the machine generated input or the user generated input belongs to the category is output; and
adjusting, by the computing device, a parameter of the prediction network based on the first score and the second score.

2. The method of claim 1, further comprising:
analyzing the machine generated input to generate a first set of tokens that represent the machine generated input; and
analyzing the user generated input to generate a second set of tokens that represent the user generated input.

3. The method of claim 2, further comprising:
generating a first set of embeddings from the first set of tokens; and
generating a second set of embeddings from the second set of tokens, wherein the first set of embeddings represents the machine generated input in a space and the second set of embeddings represents the user generated input in the space.

4. The method of claim 1, further comprising:
generating a first set of embeddings from the machine generated input; and
generating a second set of embeddings from the user generated input, wherein the first set of embeddings and the second set of embeddings are analyzed by the prediction network.

5. The method of claim 1, wherein the link is based on a previous issue ticket and a previous error report being correlated together.

6. The method of claim 1, wherein generating the first score comprises:
generating the first score that represents a similarity between the type of machine generated input and the type of user generated input.

7. The method of claim 1, wherein the first score is a vector.

8. The method of claim 1, wherein adjusting the parameter of the prediction network comprises:
adjusting the second score using the first score to generate an adjusted score, and
adjusting the parameter based on the adjusted score.

9. The method of claim 8, wherein the parameter is adjusted based on a difference between the adjusted score and the second score.

10. The method of claim 1, further comprising:
outputting a plurality of categories in which to categorize the machine generated input.

11. The method of claim 10, wherein the plurality of categories is extracted from the machine generated input or the user generated input.

12. The method of claim 10, further comprising:
determining a priority of a category in the plurality of categories based on a number of instances of machine generated input or user generated input that is classified in the category.

13. The method of claim 1, wherein the category is associated with an issue ticket and a resolution for the issue ticket.

14. The method of claim 1, wherein:
the machine generated input comprises an error report that is automatically generated by an application, and
the user generated input is generated by a user based on the user using the application.

15. A non-transitory computer-readable storage medium having stored thereon computer executable instructions, which when executed by a computing device, cause the computing device to be operable for:
receiving machine generated input and user generated input for training a model of a prediction network;
receiving a link between a type of machine generated input and a type of user generated input;
generating a first score that represents a correlation between the type of machine generated input and the type of user generated input;
analyzing the machine generated input and the user generated input using the model of the prediction network to correlate the machine generated input and the user generated input to a category, wherein a second score associated with a confidence that the machine generated input or the user generated input belongs to the category is output; and
adjusting a parameter of the prediction network based on the first score and the second score.

16. The non-transitory computer-readable storage medium of claim 15, wherein generating the first score comprises:
generating the first score that represents a similarity between the type of machine generated input and the type of user generated input.

17. The non-transitory computer-readable storage medium of claim 15, wherein adjusting the parameter of the prediction network comprises:
adjusting the second score using the first score to generate an adjusted score, and
adjusting the parameter based on the adjusted score.

18. The non-transitory computer-readable storage medium of claim 15, further operable for:
outputting a plurality of categories in which to categorize the machine generated input.

19. The non-transitory computer-readable storage medium of claim 18, wherein the category is associated with an issue ticket and a resolution for the issue ticket.

20. An apparatus comprising:
one or more computer processors; and
a computer-readable storage medium comprising instructions for controlling the one or more computer processors to be operable for:
receiving machine generated input and user generated input for training a model of a prediction network;
receiving a link between a type of machine generated input and a type of user generated input;
generating a first score that represents a correlation between the type of machine generated input and the type of user generated input;
analyzing the machine generated input and the user generated input using the model of the prediction network to correlate the machine generated input and the user generated input to a category, wherein a second score associated with a confidence that the machine generated input or the user generated input belongs to the category is output; and
adjusting a parameter of the prediction network based on the first score and the second score.
